(19) United States
(12) Patent Application Publication
(10) Pub. No.: US 2018/0077741 A1
(43) Pub. Date: Mar. 15, 2018

(54) WIRELESSLY-NETWORKABLE DEVICE AND METHOD OF CONFIGURING SUCH A DEVICE

(71) Applicant: ICM Controls Corporation, North Syracuse, NY (US)

(72) Inventors: Weidong Pan, Morganville, NJ (US); Ayham Boucher, Skaneatels (SY); Andrew S. Kadah, Manlius, NJ (US)

(21) Appl. No.: 15/263,956

(22) Filed: Sep. 13, 2016

(51) Int. Cl. H04W 76/02; H04W 12/08

(52) U.S. Cl. CPC H04W 76/021; H04W 84/12; H04W 12/08

(57) ABSTRACT

A method of configuring a device includes associating a network-connectable device (such as a Wi-Fi thermostat) with a first identifier (such as a first account) established on a network server; using a mobile communication device (such as a smartphone), accessing the network-connectable device using the first identifier, and setting or verifying in the network-connectable device one or more operating parameters (such as a set-point) of the network-connectable device; after setting or verifying the one or more operating parameters, removing the association of the network-connectable device with the first identifier, and permitting association of the network-connectable device with a second identifier (such as a second account) established or to-be-established on a network server and access to the network-connectable device and verification or setting of the one or more operating parameters of the network-connectable device using the second identifier.

### BACKGROUND

This disclosure relates generally to wirelessly-networkable devices. The disclosure is more specifically directed to network-connectable device, such as network-connectable controllers, including thermostats, sometimes known as “Wi-Fi thermostats,” adapted to interact with a computer program, such as one running on a mobile device (“mobile app”), as well as connectable to, and configurable by, a remote server. The disclosure is also directed to a method of configuring such a device by a mobile device and thereafter transferring the control of the device to a remote server.

Network-connectable devices, such as Wi-Fi thermostats for an HVAC (heating, ventilation and air conditioning) system, can be installed and configured either by the ultimate user, such as a homeowner, or a supplier, such as a contractor. To be able to remotely control the network-connectable device through a computer network, the network-connectable device typically needs to be connected to the network, e.g., via a Wi-Fi access point. Such a connection typically requires certain credentials, such as a password or key, be provided network connectable device. While it may be advantageous to use contractors to install network-connectable devices for the user, it may be undesirable to provide a contractor with the user's (e.g., homeowner's) credentials for accessing the network. Authorization, even if temporary, for the installer to access the homeowner's access point exposes homeowner's network service and other resources to potential unauthorized use.

Thus an unmet need exists to facilitate installation and setting of a network-connectable device for the ultimate user of the device without having to authorize the installer to access the user's network services.

### SUMMARY

One aspect of the disclosure relate to a method of configuring a device, the method including: associating a network-connectable device (such as a Wi-Fi thermostat) with a first identifier (such as a first account) established on a network server; using a mobile communication device (such as a smartphone), accessing the network-connectable device using the first identifier, and setting or verifying in the network-connectable device one or more operating parameters (such as a set-point) of the network-connectable device; after setting or verifying the one or more operating parameters, removing the association of the network-connectable device with the first identifier, and permitting association of the network-connectable device with a second identifier (such as a second account) established or to-be-established on a network server and access to the network-connectable device and verification or setting of the one or more operating parameters of the network-connectable device using the second identifier. Accessing of the network-connectable device using the first identifier can include causing the network-connectable device to connect to a first Wi-Fi access point (such as one provided by the contractor's smartphone), and permitting access to the network-connectable device can include permitting the network-connectable device to connect to a second Wi-Fi access point and permitting a network communication device to access the network-connectable device via a computer network and the second access point.

In another aspect of the disclosure, the mobile communication device can be used to access the network-connectable device while the network-connectable device is in an Access-Point (AP) mode. Thereafter, the network-connectable device is permitted connect to the first Wi-Fi access point. In a further aspect, the mobile communication device can be used to transmit to the network server (on which the second account is permitted to be established) a command indicative of an identifier (such as service-set identifier (SSID), MAC address, a thermostat ID which is an unique identification of the thermostat set by the factory, etc.) of the network-connectable device, and permitting association of the network-connectable device with a second identifier established on the network server. Permitting association of the network-connectable device with a second identifier established on the network server can be accomplished by, for example, dissociating the network-connectable device from the first identifier.

In a further aspect of the disclosure, as a part of permitting association of the network-connectable device with a second identifier established on a network server, an electronic message can be sent to the ultimate user (for example, the user associated with the second account), the message containing information (such as instructions) for associating the network-connectable device with the second identifier.

The network-connectable device can be any suitable device, including a controller, such as a thermostat. The operating parameter can be a reference parameter, such as a reference temperature (or reference signal level from the temperature sensor) based on which the controller is adapted to control the operation of another device, such as an HVAC component (e.g., furnace or air conditioning unit). In another aspect of the disclosure, the operating parameters of the network-connectable device can also include a program of a time sequence of operations of the network-connectable device.

In another aspect of this disclosure, a configuring device includes a mobile communication device that includes a processor, a communication interface (such as a wireless communication interface) operatively connected to, and controlled by, the processor and adapted to exchange data with another device, and a user interface operatively connected to the processor. The processor is a special-purpose processor programmed to perform the functions of: associating a network-connectable device with a first identifier established on a network server; accessing the network-connectable device using the first identifier, and setting or verifying in the network-connectable device one or more operating parameters of the network-connectable device; and after setting or verifying the one or more operating parameters, removing the association of the network-connectable device with the first identifier, and permitting association of the network-connectable device with a second identifier established on a network server and access to the network-connectable device and/or setting of the one or more operating parameters of the network-connectable device using the second identifier.

### BRIEF DESCRIPTION OF THE DRAWINGS

FIG. 1 schematically shows a network-connectable device, in this example a Wi-Fi thermostat, connectable and remotely configurable by a mobile device and another device via a computer network.

FIG. 2 schematically shows screenshots showing connection of a Wi-Fi thermostat to an access point provided by a mobile device in an exemplary process. The illustrated process is typical for Android devices.

FIG. 3 schematically shows screenshots showing connection of a Wi-Fi thermostat to an access point provided by a mobile device in another exemplary process. The illustrated process is typical for iOS devices.

FIG. 4 show a flowchart outlining a process of connecting a Wi-Fi thermostat to an access point provided by a mobile device in an exemplary process.

FIG. 5 schematically shows a mobile device for configuring a network-connectable device according to an aspect of this disclosure.

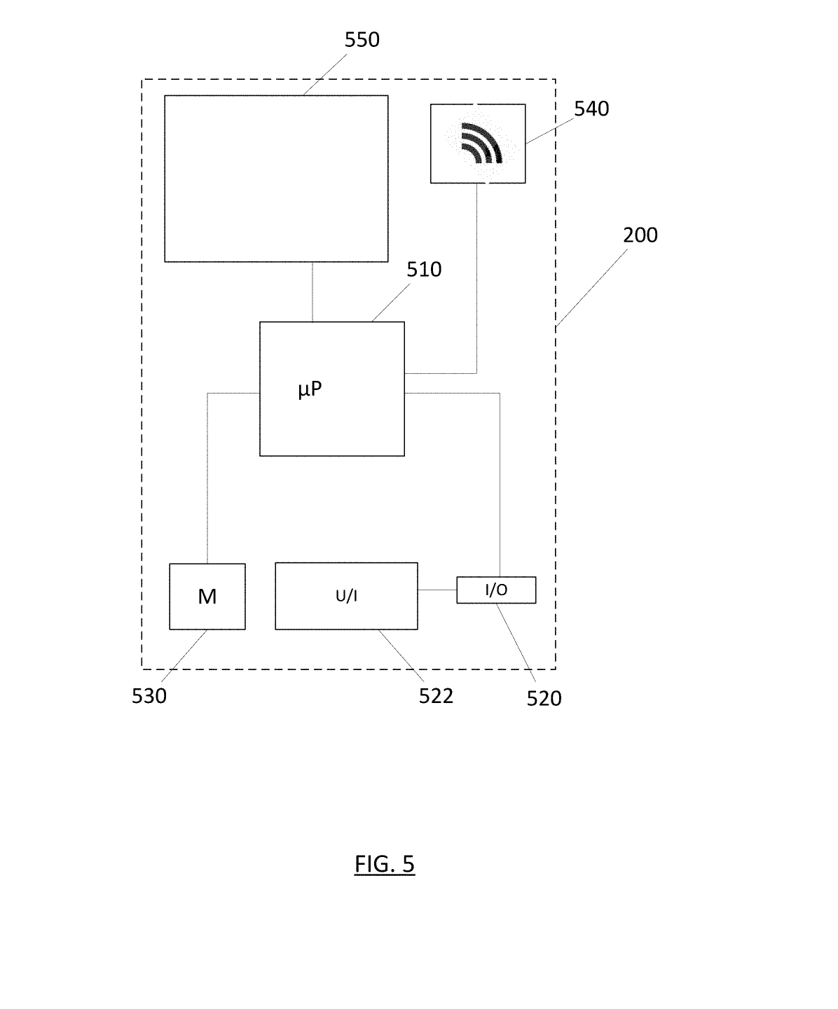

### DETAILED DESCRIPTION

Specific embodiments of the invention are given below as non-limiting examples.

The exemplary methods and devices disclosed herein are applicable in a variety of situations, including where a network-connectable device such as a Wi-Fi thermostat is installed by a contractor for an end user who will ultimately be remotely controlling the network-connectable device via a computer network, such as the Internet. For example, when a contractor is at a home to service an HVAC equipment, he/she may find a thermostat that needs to be replaced. The contractor may learn that the homeowner wishes to install a Wi-Fi thermostat as a replacement. The contractor may need the homeowner's Wi-Fi router's information (e.g., SSID, password) in order to connect the thermostat to the router and test the thermostat. Alternatively, the contractor can ask to gain access to the router to use the “Wifi Direct” method to connect if both the router and the thermostat have that feature. But the person at home might not want to, not be able to, or not be authorized to give him the access. However, it may be undesirable to provide a contractor such a level of access to the homeowner's resources.

In one aspect of the disclosure, a method of configuring a network-connectable device utilizes a mobile communication device, such as a smartphone, that is programmed to provide an access point, connect the network-connectable device to the access point, configure the network-connectable device via a network and the access point, and thereafter transfer the control of the network-connectable device to the end user. To install a Wi-Fi thermostat for example, a typical contractor may use a smartphone that have a built-in “mobile hotspot” feature, which allows the smartphone to receive cellular signal and operator as an access point so a Wi-Fi device can connect to it and through it to a web server on the Internet. The smartphone can also run a program (an “App”), which makes the smartphone a special-purpose processor for carrying out processes of configuring the thermostat according aspects of this disclosure.

For example, Wi-Fi thermostats and the webservers in certain cases provide API support. With provided API, the App will be able to configure the thermostat to connect to its own mobile hotspot. The App can configure the mobile hotspot to be available. This way the thermostat will successfully connect to the internet and communicate with the service on the webserver. At the same time, the App will have access to the Internet as well and can check the thermostat status and configure the thermostat via the web service provided by the web server. This way the contractor will check the health of the thermostat's communication and will be able to use the App to configure the thermostat as desired.

After the contractor is done configuring and testing the thermostat, he/she can transfer the ownership of the thermostat to the homeowner using the App. In one example, the contractor can indicate, through a user interface of the smartphone, that the installation process (including checking and/or configuring the thermostat) is complete. Upon such an indication, the App can automatically issue one or more messages to the web server. The message can contain information about the network-connectable device, such as the network ID of the thermostat, as well as information about the end user, such as the user's email address. The message can cause the web server to notify the homeowner (e.g., by email), with instructions on how to create the users account on the webserver in case they do not have one and details of how to add the thermostat to their account. The thermostat will be operational and the homeowner will be able to control it over the internet after following the instructions in the email.

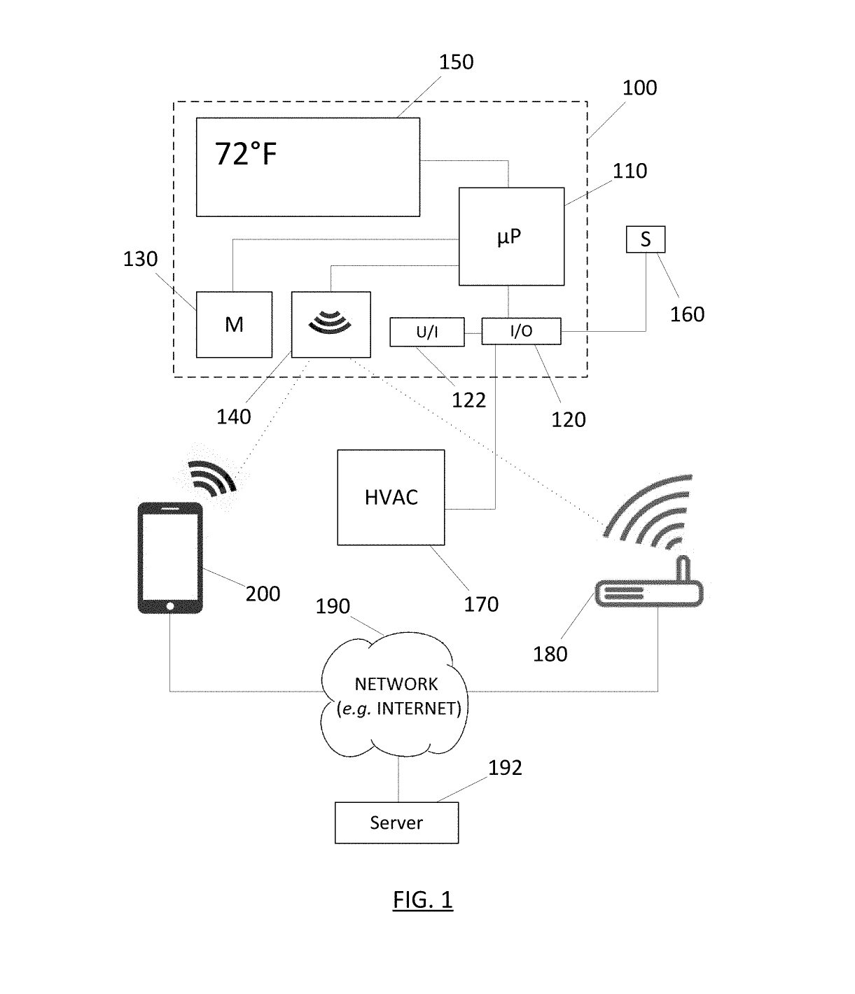

FIG. 1 schematically shows a system in which the process according an aspect of this disclosure can be carried out. A Wi-Fi thermostat 100 includes a microprocessor 110. Operatively connected to the microprocessor 110 are an I/O module 120, memory 130, wireless communication module 140 and display 150. Operatively connected to the I/O module are a user interface 122, sensor 160 (such as a temperature sensor) and an HVAC system 170, which the thermostat 100 controls. In operation, the microprocessor 110 takes the signal from the sensor 160, controls the system 170 according to the instructions stored in the memory 140 and displays various information, such as temperature, set points and time of day, on the display 150.

The Wi-Fi thermostat 100 is adapted to be operatively connected to a computer network such as the Internet 190. The connection can be a wireless connection, for example, via the wireless communication module 140 an Wi-Fi access point 180. One or more servers 192 are also connected to the network 190. Programs, such web services, for remote configuration of Wi-Fi thermostats can run on the server(s) 192. A user (such as a contractor) can establish a first identifier, such as a first user account, on the server(s) 192 and register the thermostat 100 with the web service under that account. The user (or anyone authorized by the user) can then log in the first user account via any suitable device (e.g., a personal computer or a smartphone) and configure the thermostat 100 through the network 190.

According to an aspect of the disclosure, a mobile communication device, such as a smartphone 200, used by the installer, is adapted (e.g., by running a software program (App)) to communicate with the network-connectable device 100 via the wireless communication module 140.

In an aspect of the disclosure, a mobile communication device 200 includes a microprocessor 510. Operatively connected to the microprocessor 510 are an I/O module 520, memory 530, wireless communication module 540 and display 550. Operatively connected to the I/O module is a user interface 522. The microprocessor 510 is programmed, for example by a software program (or “App”) to be a special-purpose process to perform processes according to this disclosure. In operation, the mobile communication device 200 communicates with the server(s) 192 (via the Internet 190) as well as with the network-connectable device 100 via the wireless communication module 540 and performs other function according to aspects of this disclosure according to the instructions stored in the memory 540, and displays various information on the display 550.

In one exemplary process, the App enables the mobile communication device 200 to first connect to the network-connectable device 100, which is in an AP mode (i.e., configured as an access point). Thereafter, the App enables the mobile communication device 200 to instruct the network-connectable device 100 to connect to the access point provided by the mobile communication device, or alternatively, to an access point provided by a mobile hotspot provided by the installer, to the computer network 190 through the access point. The App further enables the mobile communication device to associate the network-connectable device with a first identifier established on the server(s) 192 by, for example, register the network-connectable device 100 on the web service under a first account, which the installer is authorized to access.

Because the installer has the necessary credentials to allow the network-connectable device to connect to the access point provided by the smartphone of mobile hotspot, and access to the web service on which the network-connectable device is registered, the installer can then configure the network-connectable device using the mobile communication device 200, remotely through the web service. The installer can do so without ascertaining any private information such as the credentials for connection to the access point owned by the user or for accessing the user's account on the web service.

After the installer has configured the network-connectable device 100 as described above, the App enables installer issue one or more commands, through the user interface 522, to initiate a transfer of control of the network-connectable device 100. For example, the installer may indicate the end of the configuration by the installer by tapping on “End” displayed on the smartphone screen. The App enables the mobile communication device 200 to, upon the indication by the installer, issue a command to the web service. The command can include information indicative the end of the configuration by the installer, information about the network-connectable device 100, such as a thermostat ID which is an unique identification of the thermostat set by the factory (e.g., “BGQGRIGYKRRV” and “BGQHDITLTXBY”) and an email address of the end user or ultimate user of the network-connectable device 100. The command causes the web service to notify (e.g., by email) the end user of the completion of the installation and configuration of the network-connectable device (100) by the installer and provide the end user with instructions on registering the network-connectable device 100 with the web service under the end user's existing or to-be-established account. The command can also cause the web service to remove the registration of the network-connectable device under the account with which the installer configured the network-connectable device 100.

The end user will have full control of the network-connectable device 100 after following the instructions sent by the web service.

### Example for a Wi-Fi Thermostat Installed in a Residential Setting:

This is where a contractor will be able to install a thermostat without the need for a homeowner's home Wi-Fi network credentials.

The contractor can use a Personal Hotspot if they have one handy. The contractor can simply connect the thermostat to the hotspot and then register it to the first account and test it through the mobile App. After the testing/configuration is completed the contractor transfers the thermostat ownership (full control) to the homeowner and instructs the homeowner on how to proceed as described above.

If the contractor does not have a personal hotspot, a mobile phone with a mobile hotspot feature may be used. The contractor will be able to use an automated method to connect the thermostat to their Mobile Hotspot and be able to provision, test and configure the thermostat as desired.

This method depends on an established means of communication between the Mobile App and the thermostat. An exemplary communication mode is called “Device AP mode,” where the thermostat is in AP mode and the Mobile Device is connected to this AP. This allows the Mobile App to send/receive information to the thermostat.

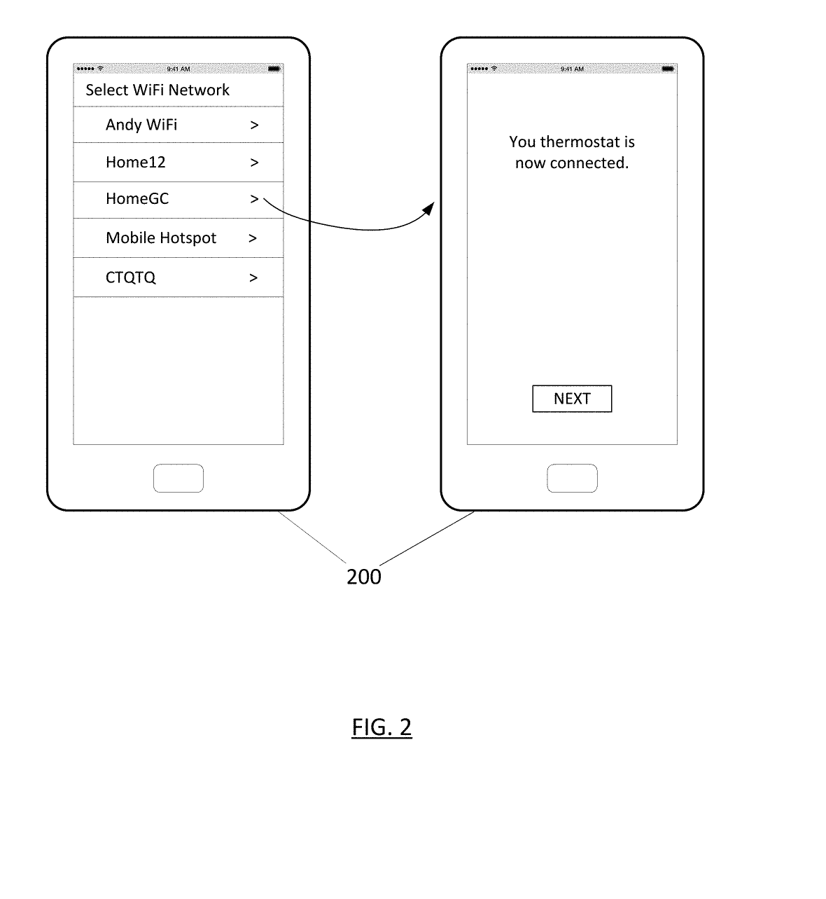

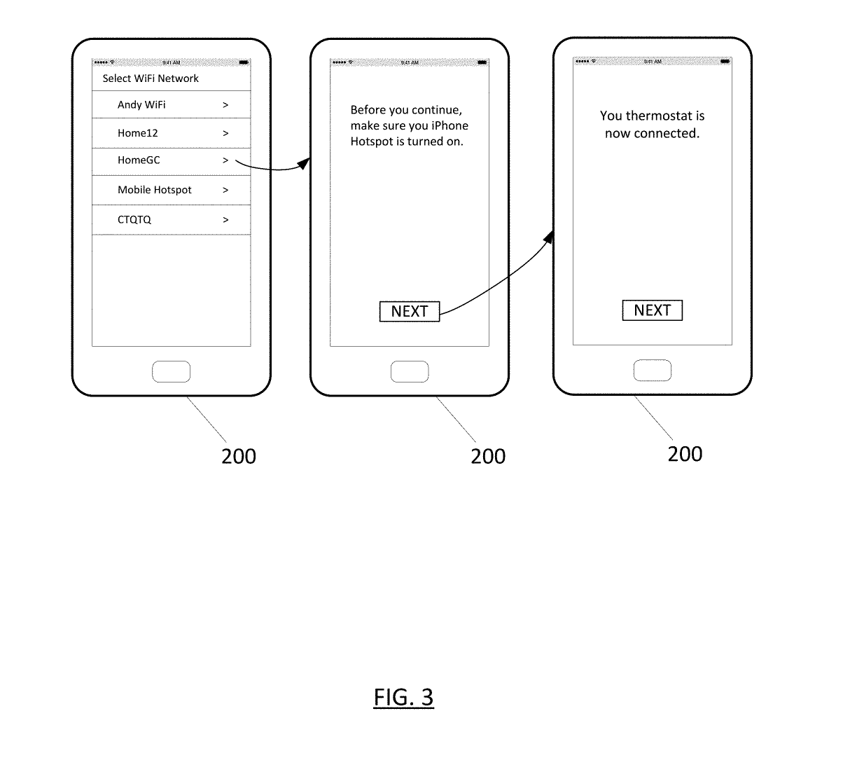

FIG. 2 illustrates an exemplary contractor experience when using the Mobile Hotspot feature to provision the thermostat using a mobile phone running the Google Android operating system. FIG. 3 illustrates an exemplary contractor experience when using the Mobile Hotspot feature to provision the thermostat using a mobile phone running the Apple iOS operating system. The user interfaces are slightly different between the two platforms in that the contractor has one extra step using Apple iOS to manually turn on their Mobile Hotspot.

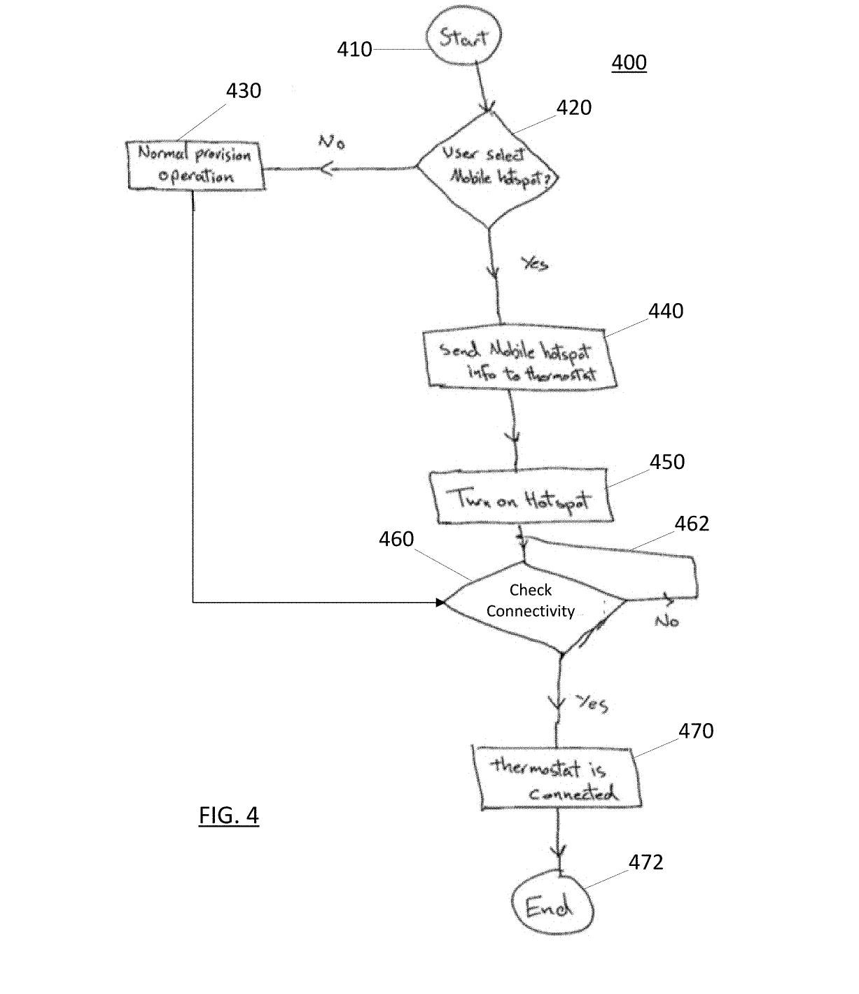

FIG. 4 shows an exemplary flow chart for the process 400 of connecting to Mobile Hotspot. After the start 410 of the App, the contractor is provided (420) a choice of whether to use their Mobile Hotspot to provision/configure the thermostat. If the choice is “No,” normal provisioning (the same process as used by the homeowner) is used (430), and the process proceeds to “Check connectivity” (460). An example of this scenario is where the installer uses an access point other than the mobile phone running the App, or directly connect to the second Wi-Fi access point provided by the homeowner If the choice is “Yes,” the Mobile App sends information of the Mobile Hotspot of the mobile phone to the thermostat (440). Next, the Mobile App enables the Mobile Hotspot (450) and checks the thermostat's connectivity to the web service to confirm the thermostat has Internet connection established (460, 462) until the connection is established (470). Thereafter the contractor can proceed with configuration/testing the thermostat.

The current “owner” of a thermostat (e.g., the contractor) can transfer ownership (control) to the future owner (e.g., homeowner). When the owner “transfers” the ownership, the App sends a command to the server. The command contains the thermostat ID and the next owner's email address. Upon receiving the command from the mobile phone, the server performs two functions: First, it removes the thermostat from the current owner (contractor)'s account. At this point, the thermostat will become ownerless, and if for any reason the current owner needs to reclaim the thermostat, he/she can add it back to his account at any time before the next owner claims it. Second, it sends the next owner an automated email with links to download the apps and a link to an online instruction page directing the next owner what to do to claim control of the thermostat.

When the next owner (e.g., homeowner) downloads the app and follows the prompt for provisioning and register the thermostat to his/her account, the process is complete.

### Example Installation Process:

Contractor K is installing a Wi-Fi thermostat in homeowner D's house. D is not home, and the person at the home at the time is not able to provide K with any information about home Wi-Fi system.

K physically installs the thermostat. He opens the installation app on his mobile phone and taps on the “Contractor Installation” feature. The app starts the hotspot on the phone, connects the thermostat to the hotspot, then to the server. K sets up proper settings and tests the thermostat to confirm that it is operating properly.

When finished, K “transfers” the thermostat to D's email address by tapping the appropriate button in the user interface of the mobile phone indicating the end of installation and then leaves.

D comes home and sees the thermostat is operating properly. D receives the email the server sent him and clicks the provided link to download the app for the end user. D signs up an account with the web service. From this point on, D is able to provision the thermostat to the home router and add the thermostat to his account. D will then be able to remotely control the thermostat through the network.

Many modifications and variations of the examples disclosed herein, and numerous other embodiments of the invention can be made without exceeding the scope of the invention, which is to be measured by the claims hereto appended.

1. A method of configuring a device, the method comprising:
associating a network-connectable device with a first identifier established on a network server;
using a mobile communication device, accessing the network-connectable device using the first identifier, and verifying or setting in the network-connectable device one or more variables or operating parameters of the network-connectable device;
after verifying or setting the one or more variables or operating parameters, permitting association of the network-connectable device with a second identifier established, or to be established, on a network server and access to the network-connectable device and verification or setting of the one or more variables or operating parameters of the network-connectable device using the second identifier.

2. The method of claim 1, wherein accessing the network-connectable device using the first identifier comprises causing the network-connectable device to connect to a first Wi-Fi access point, wherein permitting access to the network-connectable device comprises permitting the network-connectable device to connect to a second Wi-Fi access point and permitting a network communication device to access the network-connectable device over a computer network via the second access point.

3. The method of claim 1, wherein associating the network-connectable device with the first identifier established on a network server comprises permitting a user associated with a first account established on a network server to access the network-connectable device through a computer network, and wherein permitting association of the network-connectable device with a second identifier established, or to be established, on a network server comprises permitting a user associated with a second account established, or to be established, on a network server to access the network-connectable device through a computer network.

4. The method of claim 2, wherein causing the network-connectable device to connect to a first Wi-Fi access point comprises using the mobile communication device to access the network-connectable device while the network-connectable device is in an Access-Point (AP) mode and thereafter permitting the network-connectable device to operate the network-connectable device to connect to the first Wi-Fi access point.

5. The method of claim 3, wherein permitting association of the network-connectable device with a second identifier established, or to be established, on a network server comprises transmitting from the mobile communication device to the network server a command indicative of an identifier of the network-connectable device.

6. The method of claim 5, wherein permitting association of the network-connectable device with a second identifier established, or to be established, on a network server further comprises causing an electronic message to be sent to the user associated, or to be associated, with the second account, the message containing information for associating the identifier of the network-connectable device with the second account.

7. The method of claim 1, wherein the network-connectable device comprises a controller, wherein the one or more variables or operating parameters comprise a reference parameter based on which the controller is adapted to control the operation of another device.

8. The method of claim 7, wherein the network-connectable device comprise a thermostat, wherein the reference parameter is a reference temperature, the controller being configured to operate a heating or cooling system to drive the temperature of a controlled area toward substantially the reference temperature.

9. The method of claim 1, wherein verifying or setting in the network-connectable device one or more variables or operating parameters of the network-connectable device comprises programming a time sequence of operations of the network-connectable device.

10. A configuring device, comprising:
a mobile communication device comprising a processor, a communication interface operatively connected to, and controlled by, the processor and adapted to exchange data with another device, and a user interface operatively connected to the processor, the processor being a special-purpose processor programmed to perform:
associating a network-connectable device with a first identifier established on a network server;
accessing the network-connectable device using the first identifier, and verifying or setting in the network-connectable device one or more variables or operating parameters of the network-connectable device;
after verifying or setting the one or more variables or operating parameters, permitting association of the network-connectable device with a second identifier established, or to be established, on a network server and access to the network-connectable device and verifying setting of the one or more variables or operating parameters of the network-connectable device using the second identifier.

11. The configuring device of claim 10, wherein the communication interface comprises a wireless communication interface.
